(19) United States
(12) Patent Application Publication
(10) Pub. No.: US 2017/0177224 A1
(43) Pub. Date: Jun. 22, 2017

(54) DYNAMIC STORAGE TRANSITIONS EMPLOYING TIERED RANGE VOLUMES

(71) Applicant: Oracle International Corporation, Redwood Shores, CA (US)

(72) Inventors: Frederick S. Glover, Hollish, NH (US); Mark Longo, Dunstable, MA (US); Joshua Smith, Brookline, NH (US)

(21) Appl. No.: 14/975,971

(22) Filed: Dec. 21, 2015

(51) Int. Cl. G06F 3/06

(52) U.S. Cl. CPC G06F 3/0604; G06F 3/0631; G06F 3/0647

(57) ABSTRACT

Techniques are provided for efficiently managing multi-tier storage systems with multiple types of storage class tiers encompassed in a single tiered range volume. In an embodiment, a storage manager creates a first virtual volume, where the storage manager exposes to a first tiered range volume client a first virtual address range for the first virtual volume that represents logical addresses of data blocks within storage portions from at least two storage class tiers of a set of multiple storage class tiers. Each storage portion represents an allocated range from a storage class tier. A storage class tier represents a set of multiple storage devices. The storage manager maintains a storage map of storage portions from multiple storage class tiers to the first virtual address range within the first virtual volume which includes mapping a first virtual address to a first logical address within a first storage portion from a first storage class tier and mapping a second virtual address to a second logical address within a second storage portion from a second storage class tier. A tiered range volume client of the first virtual volume stores a first data block at a first address within the first storage portion. Then the storage manager adds a third storage portion from a third storage class tier to the first virtual volume that maps to a third allocated range, where the third allocated range of the first virtual volume covers at least a portion of the first allocated range, including the first address where a first data block is stored. When adding a third storage portion, the storage manager modifies the storage map to map the first virtual address for the first data block to a location within the third storage portion. The storage manager then moves the first data block to the third storage portion within the third storage class tier that corresponds to a location corresponding to the first address within the third storage portion.

### FIELD OF THE INVENTION

The present invention relates to multi-tiered storage management. More specifically, presenting a single storage volume, made up of multiple storage tiers, that allows for transparently modifying the storage tiers and remapping data blocks from one storage tier to another storage tier.

### BACKGROUND

Data storage requirements for computer applications have become more and more complex. Applications require the need to read and write many different types of data to different types of storage devices. For example, a computer application may require very high-speed access to specific data related to stock trading. In response to this requirement, application data related to stock trading may be stored on high-speed (high-availability) storage devices such as Solid State Device (SSD) memory. The same computer application may also require storage of historical stock trade data. The historical data may not require high-speed availability but, may require storage on devices with specific policies such as RAID so as to conform with governmental policies like Sarbanes-Oxley. Policies for data may include techniques such as mirroring or striping. In order to meet the demands of computer applications as described above, computer applications may require different storage devices, one storage device for the high-availability data and another storage device for data that requires mirrored backups.

Contemporary storage solutions may implement a multi-tiered storage solution which includes supplying computer applications with different types of storage devices. Contemporary multi-tiered storage solutions are implemented by a combination of a device manager that manages multiple storage devices. A device manager is a server computer configured to manage different types of storage devices within a storage class tier and to present the storage devices to a client as a logical storage volume. A client may be defined as an application running on one or more computers that requires data storage. A logical storage volume is a collection of physical storage volumes from one or more storage devices presented as a single storage volume to a client. The device manager provides a layer of abstraction between the physical address of each storage device and the logical address that the client sees. The device manager creates the logical volume from physical storage space provided by one or more storage devices within a storage class tier. A storage class tier describes a group of storage devices that are managed by the device manager. An example of a storage class tier includes a server rack containing multiple SSD storage devices all managed by the device manager.

Drawbacks of applications using a device manager to provide a logical storage volume are that the device manager is limited to only the devices within its storage class tier. If the client requires more storage than what is currently available in the storage class tier, then the device manager may need to disrupt service to the logical volume in order to expand upon the current storage class tier. Other drawbacks may include that the current storage class tier capacity cannot be expanded. Another scenario which may cause service disruption is if the current storage class tier contains a heterogeneous set of storage devices and the client requires storage devices that are not currently within the heterogeneous set of storage devices, then the storage manager must disrupt service to the logical volume in order to add new types of storage devices that meet the needs of the client. In yet another scenario, the storage manager may be unable to add new types of storage due to static limitations of equipment or storage space.

Device managers are also limited by the type of storage policy they can provide. Storage policies managed by device managers are limited to configurations based on the storage class tier or storage device type. This limitation restricts multiple clients from having unique customized storage and migration policies.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an embodiment of a storage management system.

FIG. 2A depicts an embodiment of a storage portion table where different tiers of a tiered range volume are defined.

FIG. 2B depicts an embodiment of a data migration policy for a tiered range volume.

FIGS. 3A and 3B depict embodiments of the process by which the storage manager modifies storage tiers and remaps tiered range volume address range to logical address range within a storage portion.

FIG. 4 depicts an embodiment of a graphical representation of the newly created tiered range volume.

FIG. 5A depicts an embodiment of an updated storage portion table with a newly added storage class tier.

FIG. 5B depicts an embodiment of an updated migration policy accounting for the newly added storage class tier.

FIG. 6 depicts an embodiment of an updated graphical representation of the tiered range volume with the newly added storage class tier.

FIG. 7A, FIG. 7B, and FIG. 7C depict embodiments of an updated storage portion table where the sizes of storage portions have been modified.

FIG. 8A depicts an embodiment of an updated storage portion table where underlying storage devices within a storage class tier have been replaced with new storage devices.

FIG. 8B depicts an embodiment of an updated migration policy accounting for the new storage devices within the updated storage class tier.

FIG. 9 depicts an embodiment of an updated graphical representation of the tiered range volume with the new storage devices within the updated storage class tier.

FIG. 10 is a block diagram illustrating a computer system that may be used to implement the techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for efficiently managing multi-tier storage systems with multiple types of storage class tiers and transparently presenting a storage volume as a single tiered range volume to clients. A storage class tier represents a type of storage device and/or technique used to store data on the storage device. The storage class tier may include multiple similar storage devices that share a particular performance characteristic, such as speed efficiency, bulk storage, or redundancy for fault tolerance. In an embodiment, a storage manager creates a first tiered range volume, where the storage manager exposes to a first tiered range volume client, a virtual address range that represents the first tiered range volume. The first tiered address range represents logical addresses within multiple storage portions from at least two storage class tiers. The storage manager exposes the first tiered address range to the tiered range volume client as a single virtual address range. Each storage portion represents an allocated logical address range from a storage class tier. The storage manager maintains a storage map of storage portions from multiple storage class tiers that are used to create the first tiered address range, which is exposed to the tiered range volume client as a single virtual address range. The storage map, managed by the storage manager, defines mapping for a first virtual address to a first logical address within a first storage portion from a first storage class tier and defines mapping for a second virtual address to a second logical address within a second storage portion from a second storage class tier. A tiered range volume client of the first virtual volume stores a data at the first virtual address which currently is mapped to the first logical address within the first storage portion.

Then the storage manager adds a third storage portion from a third storage class tier to the first virtual volume that maps to a third allocated range, where the third allocated range of the first virtual volume covers at least a portion of the first allocated range, including the first virtual address where the data is stored.

When adding a third storage portion, the storage manager modifies the storage map to map the first virtual address for the data to a location within the third storage portion. The storage manager then moves the data to the third storage portion within the third storage class tier that corresponds to a location corresponding to the first address within the third storage portion.

### Storage Manager System Architecture

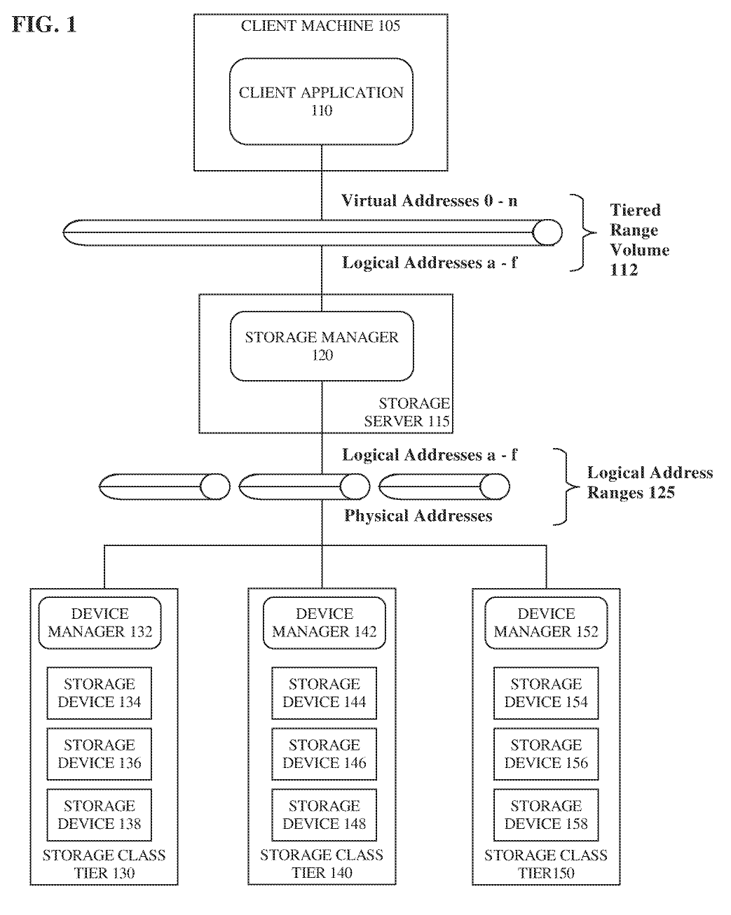

FIG. 1 is a block diagram that depicts an example network arrangement for a maintaining a tiered range volume for a user, according to embodiments. A tiered range volume is a single volume made up of multiple storage ranges from multiple storage class tiers. Despite being made up of multiple storage class tiers, the tiered range volume is presented to tiered range volume clients, such as users and applications, as a single virtual address range. Each storage class tier can be dynamically expanded or contracted, and new storage class tiers can be dynamically integrated or removed from the tiered range volume—however, the presentation of the tiered range volume to tiered range volume clients remains as a single virtual address range. Tiered range volume clients may read and write to data to a range of data blocks within the tiered range volume. A data block refers to a unit of memory accessed and referenced by a virtual address within the tiered range volume. The location of data blocks is maintained by mapping virtual addresses to their corresponding logical addresses.

An example network arrangement includes a client machine 105 and a storage server 115 communicatively coupled. In an embodiment, the client machine 105 and the storage server 115 may be communicatively coupled via a network. In other embodiments, the client machine 105 and the storage server 115 may be communicatively coupled on the same server node. The storage server 115 is communicatively coupled to multiple storage class tiers 130, 140, and 150 via a storage network. An example network arrangement may include other devices, including multiple client machines using multiple tiered range volumes and multiple storage class tiers, according to embodiments.

In an embodiment, the storage server 115 is communicatively coupled to storage class tiers 130, 140, and 150 via the storage network. The storage server 115 runs a storage manager 120 that creates and maintains tiered range volumes for tiered range volume clients such as a client application. Embodiments of the storage manager 120 include, but are not limited to, being implemented as a file server, volume manager, or a database application. The storage manager 120 creates a tiered range volume from one or more available storage class tiers. A tiered range volume is exposed as a virtual address range of storage that serves as an abstracted layer from the one or more allocated storage portions from storage class tiers 130, 140, and 150.

In an embodiment, storage class tiers are comprised of a homogeneous set of storage resources and a storage management controller. Each storage class tier may be characterized by the type of storage devices within that storage class tier. For example, storage class tier 130 comprises a solid state device (SSD) tier because storage devices 134, 136, and 138 are SSDs.

Within a storage class tier, a device manager provisions a volume of storage from the multiple storage devices, herein referred to as storage portions. The one or more types of storage devices include, but are not limited to, storage devices of non-volatile memory devices, SSDs, high performance hard disk drives (HDD), high capacity HDDs, virtual tape, Network Area Storage (NAS) technologies, and other device types.

In an embodiment, storage devices 134, 136, and 138, within storage class tier 130, contain physical volumes of storage. Each physical volume is a sequence of chunks called physical extents located in a physical address space on the storage devices. The device manager 132 creates a physical volume group from the set of physical extents. The device manager 132 then exposes the physical volume group as available storage portions to the storage manager 120 which views the exposed storage portion as a logical address range. In an embodiment, the device manager 132 maintains a mapping between logical addresses within the logical address range and corresponding device addresses for storage devices 134, 136, and 138. Storage device addresses may correspond to a physical address on disk or an address managed by the storage device. For example, device manager 132 may represent a NAS device which manages addresses within storage devices 134, 136 and 138.

In an embodiment, storage class tier 140 comprises high capacity HDDs because storage devices 144, 146, and 148 are high capacity HDDs within a high capacity storage array. Device manager 142 creates a physical volume group from a set of physical extents contained in storage devices 144, 146, and 148. The physical volume group maintained by device manager 142 is exposed to the storage manager 120 as available storage portions for defining a tiered address range corresponding to storage class tier 140. The device manager 142 maintains a mapping between logical addresses that represent the available storage portions and their corresponding physical addresses located on storage devices 144, 146, and 148.

In an embodiment, storage class tier 150 comprises virtual tape because storage devices 154, 156, and 158 are virtual tape storage devices within storage class tier 150. Device manager 152 creates a physical volume group from a set of physical extents contained in storage devices 154, 156, and 158. The physical volume group maintained by device manager 152 is then exposed to the storage manager 120 as available storage portions for defining a tiered address range corresponding to storage class tier 150. The device manager 152 maintains mapping between logical addresses that represent the available storage portions and their corresponding physical addresses located on storage devices 154, 156, and 158.

Other embodiments of storage class tiers may implement the use of other storage devices such as high performance HDDs and NAS technologies.

In an embodiment, the storage manager 120 creates a virtual volume. The virtual volume is configured with multiple storage portions provided by storage class tiers 130, 140, and 150. Each storage portion is defined as a mutable tiered address range that may be dynamically expanded or contracted. Additional storage portions from new storage class tiers may also be added to the tiered range volume transparently. Storage portions from existing storage class tiers may be removed from a tiered range volume transparently.

In an embodiment, the storage manager 120 maps the logical addresses of the available storage portions to virtual addresses on a tiered range volume. The expansion or reduction of the mutable address range of a storage portion may require the storage manager 120 to remap a virtual address to a different logical address within the mutable address range.

In an embodiment, the storage server 115 is communicatively coupled to a client machine 105 and provides the tiered range volume to a tiered range volume client 110 that exists on the client machine 105.

The client machine 105 may be implemented by any type of computing device running the tiered range volume client 110. The tiered range volume client 110 is a client that requires a storage volume for reading, writing, and updating data. Examples of the tiered range volume client 110 include, but are not limited to, a high performance banking application, a stock trading application, a healthcare insurance application, a file system, or any other type of application that requires read and writes to data storage.

In an embodiment, the storage manager 120 may allow one or more tiered range volume clients 110 access to the same tiered range volume. In an embodiment, the storage manager 120 may manage multiple tiered range volumes that allow access by one or more tiered range volume clients 110. Each tiered range volume may be customized to efficiently manage the tiered range volume client's 110 data. Customization may include but is not limited to, configuring the types of storage class tiers within the tiered range volume, the size of each storage portion that makes up the tiered range volume, policies that determine what type of data is to be physically stored within each storage portion, and independent data migration policies that are unique to each tiered range volume.

For example, a high performance banking application may require multiple types of data storage in order to accommodate high performance read/writes and storing large amounts of historical data. The storage manager 120 may create a single tiered range volume with attributes of a tiered range volume that are transparent to the banking application.

### Tiered Range Volume

In an embodiment, the storage manager 120 exposes the tiered range volume to the tiered range volume client 110 as a single virtual address range that is transparently mapped to multiple storage class tiers. Since the storage manager 120 transparently maps data block addresses in the tiered range volume to logical addresses in the multiple storage portions, the tiered range volume client 110 is unaware of the specific underlying storage technologies implemented within each storage class tier. FIG. 1 depicts an example of tiered range volume 112 as virtual addresses 0-n. In an embodiment, the tiered range volume client 110 only sees tiered range volume 112 as virtual addresses 0-n, while the storage manager 120 maintains mapping between virtual addresses 0-n and their underlying logical addresses, represented as logical addresses a-f. For example, the tiered range volume 112, as depicted in FIG. 1, shows mapping maintained by storage manager 120, where virtual addresses 0-n are visible to the tiered range volume client 110. Logical addresses (a-f) shown are the addresses that map to virtual addresses 0-n and are only visible to the storage manager 120. The storage manager 120 receives available logical address ranges 125 from the underlying storage class tiers 130, 140 and 150. In an embodiment, device managers 132, 142, and 152 maintain separate mapping for logical address ranges 125 to corresponding device addresses of storage portions that make up the logical address range a-f.

The benefit of this transparent mapping is that it allows storage administrators to allocate storage resources on behalf of the tiered range volume client 110, including but not limited to, expanding the range for a specific storage portion, reducing the range for a specific storage portion, adding new storage class tiers as new types of allotted storage portions, removing class tiers from the available types of storage portions, and replacing storage devices with different storage devices within a storage class tier.

In the previous example, if the tiered range volume client 110 is a high performance banking application that requires both high performance storage and bulk storage. The storage manager 120 may be configured to create a tiered range volume using allotted storage portions from multiple storage class tiers. In an embodiment, a storage administrator may configure the storage manager 120 to use multiple storage portions from the storage class tier 130 and storage class tier 140.

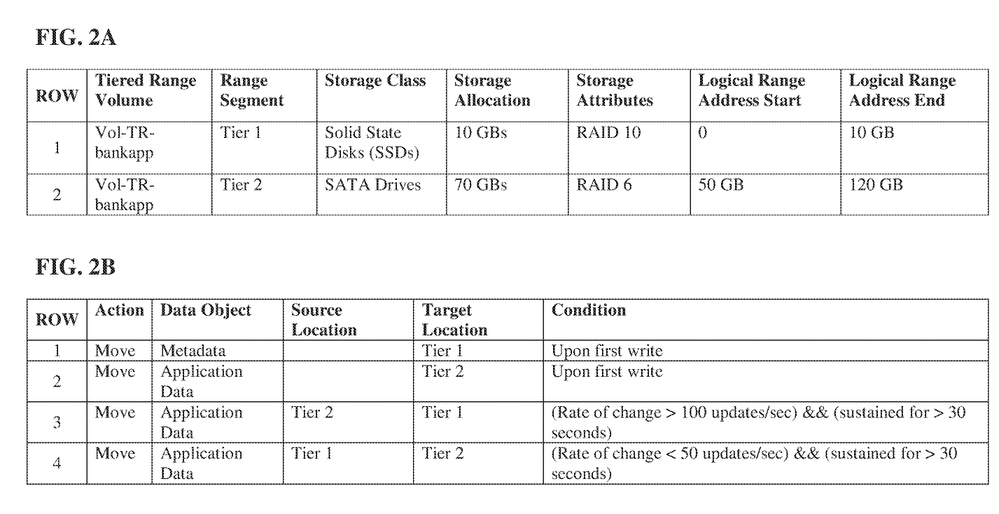

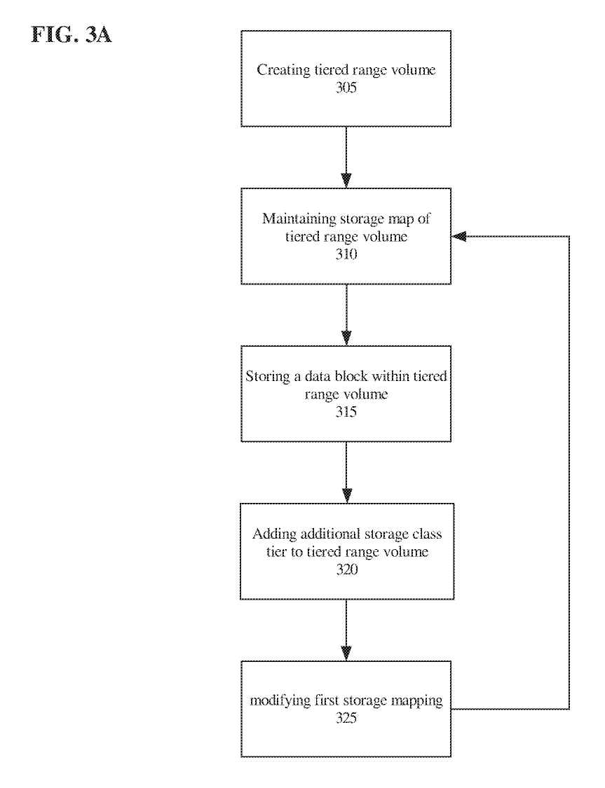

FIG. 2A depicts an embodiment of a storage portion table where storage portions from storage class tiers 130 and 140 are defined with their respective storage attributes. In FIG. 2A the tiered range volume for the high performance banking application (tiered range volume client 110) is vol-TR-bankapp. Vol-TR-bankapp is a tiered range volume represented as a single virtual address range from 0-120 GBs. The first row in FIG. 2A shows tier 1 of the multiple storage class tiers. Tier 1 is configured from storage class tier 130, which includes SSD storage devices. The administrator allocates 10 GBs of logical address space for tier 1. The storage attributes for tier 1 define RAID 10 mirroring and striping redundancy attributes. In an embodiment, the device manager 132 of storage class tier 130 manages the RAID 10 configuration by allotting extra storage device space to account for the redundancy. In another embodiment, the storage manager 120 manages the RAID 10 requirement by allotting extra storage portions and tracking multiple mappings of virtual addresses from the tiered range volume to the logical addresses of the storage portions.

In FIG. 2A, the second row shows tier 2 of the multiple storage class tiers. Tier 2 is configured from storage class tier 140, which includes high capacity storage drives such as SATA drives. The administrator allocates 70 GBs of logical address space for tier 2. The storage attributes of tier 2 defines RAID 6 double parity. In an embodiment, the device manager 142 manages the RAID 6 availability attributes and allots the extra storage devices for maintaining double parity. In an alternative embodiment, the storage manager 120 manages RAID 6 by allotting extra storage portions for maintaining double parity.

In an embodiment, allotment techniques such as thin provisioning may be implemented when initially allocating storage portions for tier 1 and tier 2. Therefore the initial allotment may not cover the entire tiered range volume range. In FIG. 2A, logical address assignments incorporate gaps within the logical address range. By doing so, the storage manager 120 and storage administrators have the flexibility to either add more storage devices to each tier's storage portion when needed or add additional class tiers as new types of storage portions. FIG. 2A depicts that tier 1 is assigned logical address range from 0 to 10 GB and tier 2 has been assigned 50 GB to 120 GB.

After provisioning multiple storage portions for a tiered range volume the storage manager 120 determines which data from the tiered range volume client 110 is written to each storage portion. In an embodiment, the storage manager 120 may use a data migration policy to determine which data is to be stored in which class tier.

### Virtual Storage Data Management

In order to achieve the storage objectives configured for the tiered range volume client 110, the storage manager 120 implements data management using a migration policy for the tiered range volume. Each tiered range volume managed by the storage manager 120 may have their own individual migration policy and therefore each tiered range volume may be customized to suit the needs of the tiered range volume client. FIG. 2B depicts an embodiment of a data migration policy for the high performance banking application. The “Action” column defines the action to take on data stored in a range of data blocks such as, move, copy, or delete. The “Data Object” column describes the type of data the rule applies on. For instance, metadata objects may have different rules than application data. The “Source location” column and the “Target location” column describe the source location of the data and the target location for the data after the action is applied. For example, if the action requires migrating data from a range of data blocks in tier 1 to a range of data blocks in tier 2, then the source location would be tier 1 and the target location would be tier 2. The “Condition” column describes when the rule is to be applied. For example, conditions may include, but are not limited to, first write to disk, data being inactive for a specific amount of time, and data becoming “hot” based on the number of times it has been updated over a specific period of time.

The first row of the migration policy as depicted in FIG. 2B defines that application metadata is to be stored, upon first write, in tier 1 storage portion. For example, if the application writes metadata to disk, then based upon the rule in row one the metadata is written to a location within the tier 1 storage portion.

The second row defines that the application data, upon first write to disk is to be stored in tier 2. The third row defines a rule based upon access characteristics of data. The application data stored in tier 2 that is updated at a frequency of more than 100 updates per second for a duration greater than 30 seconds is to be migrated to tier 1. In an embodiment, when the storage manager 120 moves the application data from tier 2 to tier 1, the storage manager 120 moves the specific data stored within a range of data blocks on tier 2 to a range of data blocks located in tier 1 and updates the mapping of the tiered range volume to reflect that the specific data is now stored within a range of data blocks located in tier 1. For example, if data object X, which represents specific data stored on a range of data blocks located in tier 2, was migrated from tier 2 to tier 1, then the storage manager 120 would update the virtual address-to-logical address mapping to reflect a new logical address. The virtual address for object X would stay the same, thus migration between tiers is transparent to the tiered range volume client 110 because the virtual address associated with object X has not changed.

The fourth row defines that application data stored in tier 1 that has been updated at a frequency of less than 50 updates per second and for a duration greater than 30 seconds are to be migrated to tier 2.

In an embodiment, modification to storage class tiers may require updating the storage class tier allocations and the data migration policy. For example, when adding a new storage class tier to the tiered range volume, new mapping may be required or remapping existing data may be required.

### Modifying Storage Class Tiers

In an embodiment, storage class tiers may be added to or removed from existing tiered range volumes without disrupting service to the tiered range volume client 110. Since the tiered range volume is an abstracted layer of multiple storage class tiers, the storage manager 120 may add or remove storage class tiers from the set of storage class tiers allocated to an existing tiered range volume. In another embodiment, the size of existing storage portion may be modified by either increasing the size of the storage portion or reducing the size of the storage portion. Since storage portions are exposed to the storage manager 120 as logical address ranges, the storage manager 120 need not be aware of the underlying storage device types of each storage portion. The level of abstraction between physical addresses and logical addresses of storage portions allows the storage manager 120 to be compatible with different and future types of tiered storage technology.

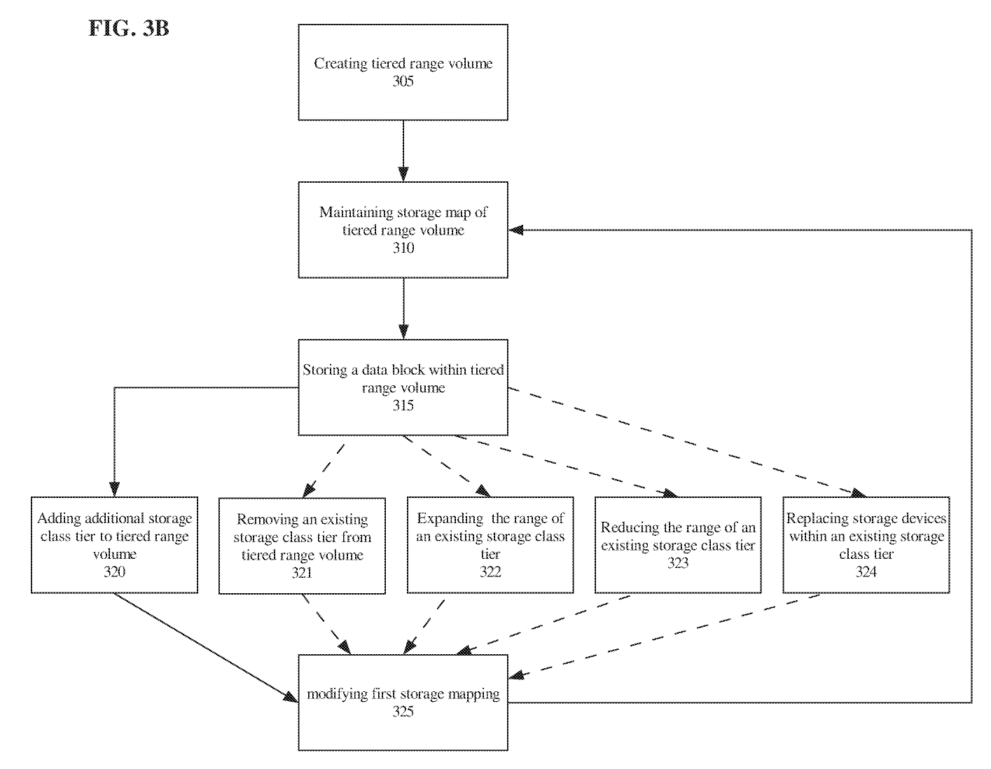

FIG. 3A depicts an embodiment of the process by which the storage manager 120 creates a new tiered range volume, manages mapping between a tiered range volume and the underlying storage class tiers, adds a new storage class tier to the tiered range volume and updating mapping of data storage between multiple storage class tiers within the tiered range volume.

Step 305 depicts the storage manager 120 creating a new tiered range volume for a tiered range volume client 110. For example, if the tiered range volume client 110 is the high performance banking application, then the storage manager 120 creates a tiered range volume based upon the requirements of the tiered range volume client 110. In an embodiment, the requirements may be communicated to the storage manager 120 in the form of required storage portions (as described in FIG. 2A) and usage of the storage portions may be configured using the data migration policy (as described in FIG. 2B). For example, storage class tiers 130 and 140 contain multiple storage devices. From these storage class tiers, the storage manager 120 uses provisioned storage portions to compile a multi-tiered range volume for tiered range volume client 110.

Step 310 depicts the storage manager 120 maintaining a storage map between the provisioned storage portions and the address space of the tiered range volume. A storage map includes mapping the virtual address range of a specific tiered range volume to logical addresses for provisioned storage portions for multiple storage class tiers. In an embodiment, the storage manager 120 may manage multiple tiered range volumes that use separate and distinct storage portions to make up each tiered range volume. Since the tiered range volumes are unique, the storage manager 120 may maintain distinct mapping as well as distinct migration policies for each tiered range volume. As described previously, the tiered range volume client 110 is only exposed to the virtual address range defined for the tiered range volume. The storage manager 120 maintains mapping between the address range defined for the tiered range volume and logical address ranges provided by the multiple device managers 132 and 142. The multiple device managers 132 and 142 maintain mapping between the logical address ranges and the physical addresses for data physically stored on storage devices within each storage class tier.

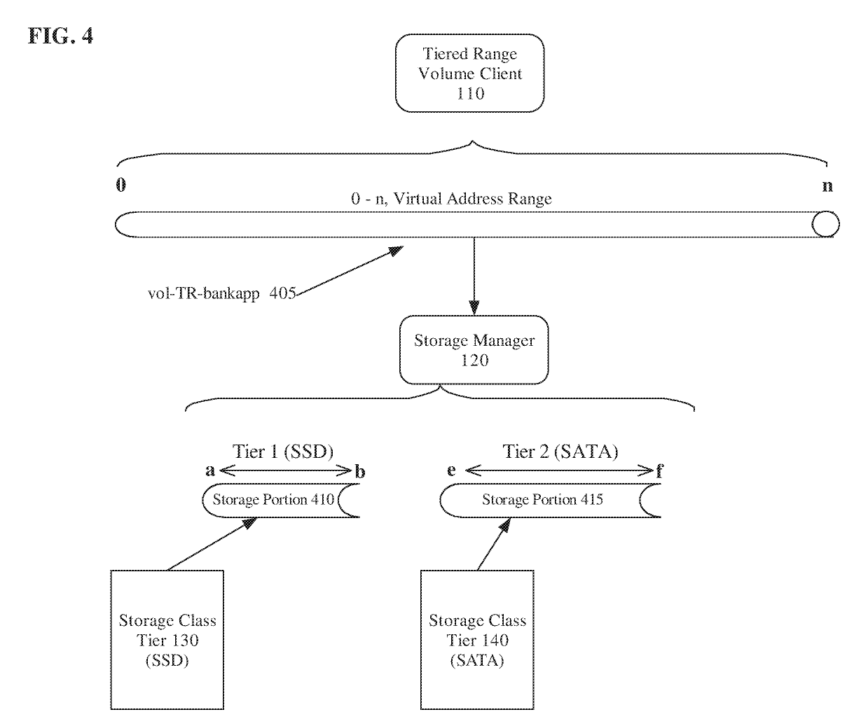

FIG. 4 is a graphical representation of the newly created tiered range volume “vol-TR-bankapp in step 305. The tiered range volume client 110 is only exposed to the vol-TR-bankapp 405, which is represented as a single virtual address range from address 0-n. In an embodiment, vol-TR-bankapp 405 is initially provisioned as a 0-120 GB virtual address range. The storage manager 120 maintains the mapping for virtual addresses in vol-TR-bankapp 405 to logical addresses corresponding to the storage class tiers available. In an embodiment, the storage manager 120 manages the mapping of data regions sized at 1 MB each. Other embodiments may configure the storage manager 120 to manage mappings of data regions of different sizes.

The tiered range volume vol-TR-bankapp 405 is initially made up of storage portion representing logical addresses from storage class tier 130 and storage class tier 140. In an embodiment, storage portion 410 is provisioned from storage class tier 130 and constitutes tier 1 storage class tier (SSD) and has a logical volume range represented as “a-b”. As described in FIG. 2A, the initial configuration for tier 1 has the logical volume range set as 0 to 10 GB.

In an embodiment, storage portion 415 is provisioned from storage class tier 140 and constitutes tier 2 storage class tier (high capacity SATA drives) and has a logical volume range represented as “e-f”. As described in FIG. 2A, the initial configuration for tier 2 has the logical volume range set as 50-120 GB. The gap between the logical address range end for tier 1, ending at 10 GB, and the logical address range start for tier 2, beginning at 50 GB, allows for expanding the logical volume range of either storage portion 410 or storage portion 415 or adding a new storage class tier without having the storage manager 120 migrate stored data and remap the tiered range volume to tiered storage mapping.

Step 315 depicts the storage manager 120 receiving a data write request to the tiered range volume. In an embodiment, when the tiered range volume client 110 writes to specific virtual address X on the tiered range volume vol-TR-bankapp 405, the storage manager 120 stores the data in a data block, or a range of data blocks depending upon the size of the data, according to the data migration policy. For example, if the data written is application data, then according to the data migration policy the application data at virtual address X in vol-TR-bankapp 405 is stored to data blocks managed by storage portion 415. The storage manager 120 creates mapping between virtual address X and logical address Y, where logical address Y refers to memory within storage portion 415. In another example, if the data written to virtual address M is metadata, then according to the data migration policy the metadata at virtual address M is stored to data blocks managed by storage portion 410, at logical address N.

Step 320 depicts the storage manager 120 adding a new storage class tier to the tiered range volume. In an embodiment, a storage administrator may decide to add an additional storage class tier to the tiered range volume. This addition may be based upon the availability of new storage class tiers, a direct request for additional tiers from the application administrators, proposed changes to more efficiently manage the data stored for the tiered range volume client 110, or triggered by configured storage capacity thresholds. Step 320, does not explicitly require the tiered range volume client 110 to write to a specific virtual address (step 315). Step 320 in FIG. 3A depicts one embodiment of adding an additional storage class tier to the tiered range volume. Other embodiments of adding additional storage class tiers may be prompted by specific actions from storage administrators, policy based triggers, or other triggers configured to add additional storage to the tiered range volume.

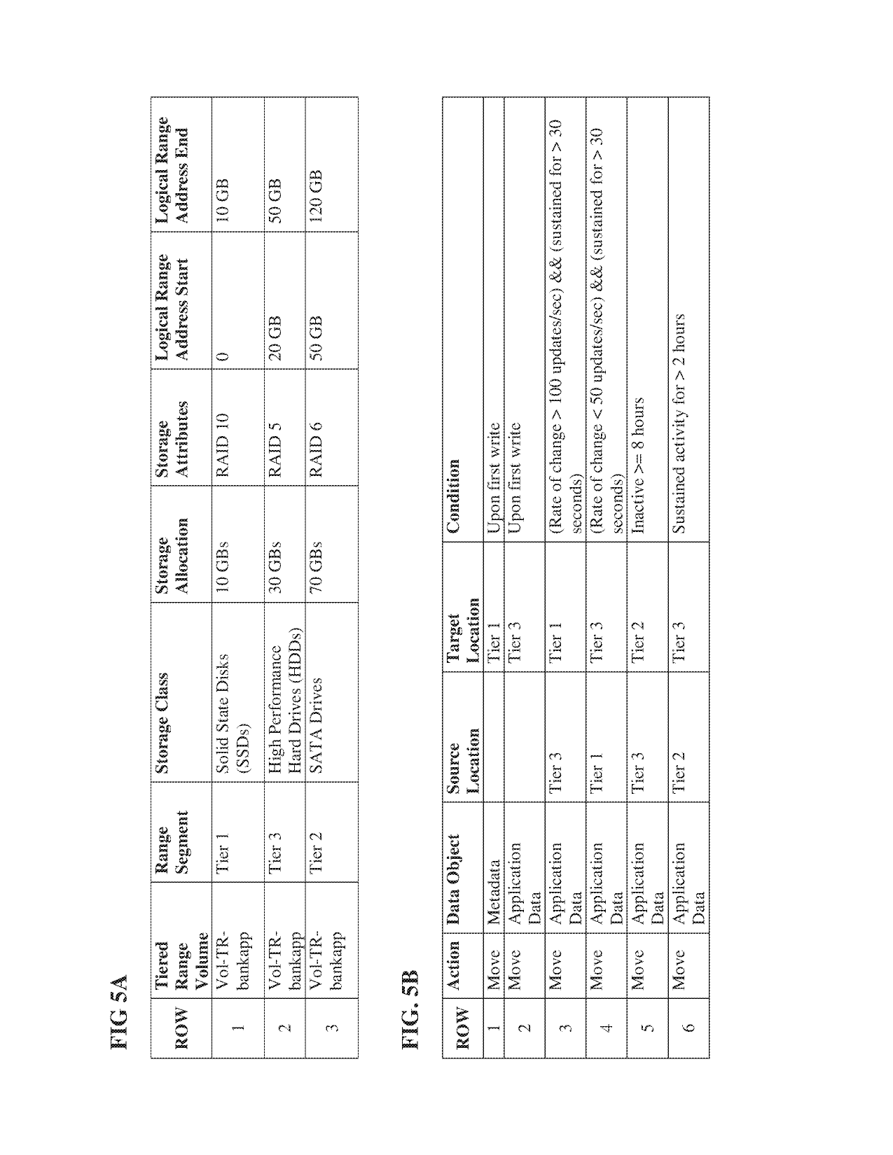

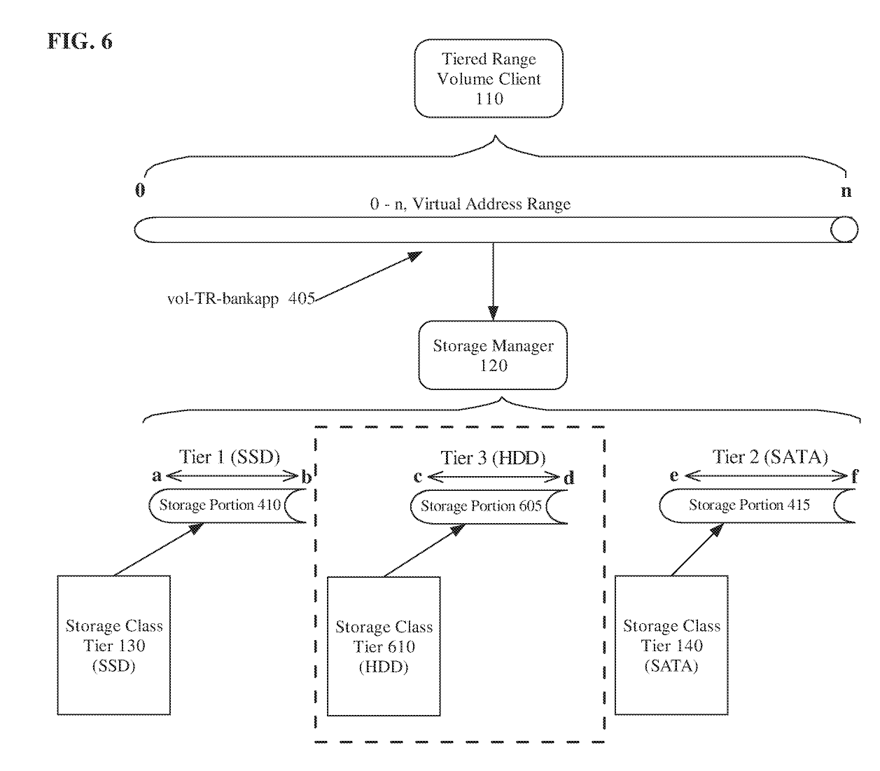

In an embodiment, the storage manager 120 may be programmed to add a new storage class tier according to an updated storage portion table. FIG. 5A depicts an updated storage portion table with an additional storage class tier. The newly added storage class tier is defined as tier 3 and is configured with High Performance Hard Drives (HDDs). FIG. 5A shows that 30 GBs of logical address space is allocated to tier 3. The storage attributes for tier 3 require RAID 5 striping with distributed parity.

In order to take advantage of the new storage class tier, the storage manager 120 implements the updated migration policy with new rules that instruct the storage manager 120 when to store data in the new tier 3 storage class tier. In an embodiment, FIG. 5B depicts the updated migration policy with updated rows accounting for the new tier 3 storage class tier. The second row in FIG. 5B reflects the update indicating that application data, upon first write is now written to tier 3 storage portion. Similarly, row three has been updated to show migration of hot application data stored in tier 3 to tier 1 when updated at a rate greater than 100 updates a second. Row 4 has been updated to show the migration of application data from tier 1 back to tier 3 when data is updated at a rate less than 50 updates per second. In an embodiment, two new rows have been added to the migration policy which utilizes the tier 2 high capacity SATA drives. Row 5 defines a rule for application data in tier 3 that has been inactive within 8 hours are to be migrated to tier 2 storage portions. In this context, inactive refers to application data that has not been read or written to within 8 hours. Row 6 defines a rule for application data in tier 2, where application data that has sustained activity for over two hours is to be migrated from tier 2 to tier 3. In an embodiment, “sustained activity” may be defined as frequency of access of data which occurs at least once every second for more than two hours. Other embodiments, may defined the frequency of activity as once every 100 milliseconds or once over 10 milliseconds depending on the migration policy defined.

FIG. 6 depicts an updated graphical representation of tiered range volume vol-TR-bankapp 405 including tier 3. Objects within the dotted square describe the addition of storage portion 605 from storage class tier 610. The logical volume range represented by “c-d” is defined as tier 3 in FIG. 5A as starting from 20 GB and ending at 50 GB.

Step 325 depicts the storage manager 120 implementing the updated migration policy and modifying tiered range volume mappings for data that needs to be migrated. In an embodiment, the storage manager 120 may move data to their new tier according to the updated migration policy. Using the previous example, application data (at virtual address X) previously stored in tier 2 based upon a first write (row 2 from FIG. 2B) may be migrated to tier 3 based upon row 6 (FIG. 5B) if the application data has sustained activity for over two hours. After migrating application data at virtual address X from tier 2 to tier 3, the storage manager 120 would update the tiered range volume mapping for vol-TR-bankapp 405 to reflect that the application data at virtual address X is now stored within the storage portion 605 (tier 3) at logical address Z. In an embodiment, tiered range volume client 110 is unaware of the data migration because the virtual address X has not changed. In an embodiment, after the storage manager 120 modifies the tiered range volume mapping in step 325, the storage manager 120 continues to maintain the storage map according to the updated migration policy (step 210).

Alternative embodiments of modifying storage class tiers include, but are not limited to, removing an existing provisioned storage portions, expanding the provisioned range of an existing storage portion, reducing the provisioned range of an existing storage portion, and replacing the underlying storage class tier for a storage portion with another storage class tier.

FIG. 3B depicts alternative embodiments of modifying storage class tiers. Steps 305, 310, and 315 are the same as the embodiment depicted in FIG. 3A where the storage manager 120 creates a new tiered range volume, maintains a storage map for the tiered range volume, and stores data in a data block within the tiered range volume. In an embodiment, the storage manager 120 may remove an existing storage class tier from the tiered range volume. Step 321 depicts the storage manager 120 removing an existing storage class tier from the set of storage class tiers used to make up the tiered range volume. For example, if the storage administrator wants to remove storage portion 415 (tier 2) and its underlying storage class tier 140 from vol-TR-bankapp 405, then the storage manager 120 would remove tier 2 according to an updated storage portion table. Rules related to tier 2 are also removed from the migration policy. According to FIG. 5B, rows 5 and 6 would be removed since they reference data either being moved into or from tier 2.

In an embodiment, step 325 depicts modifying tiered range volume mapping based upon the removal of tier 2. In this case, data currently stored in tier 2 would be moved into another tier. For example, the storage administrator may configure the storage manager 120 to automatically remap data stored in a range of data blocks located in tier 2 to another storage tier such as tier 3. Remapping may involve updating the logical-to-physical address of data to point to new physical addresses within tier 3, and then moving data to a new range of data blocks located in storage portion 605 (tier 3).

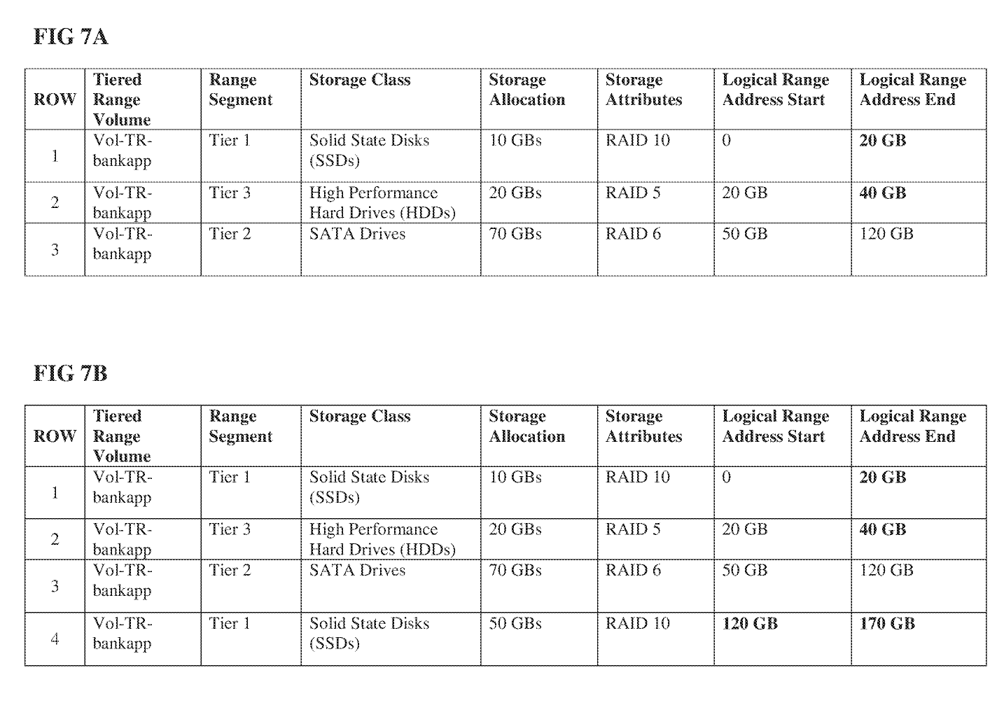

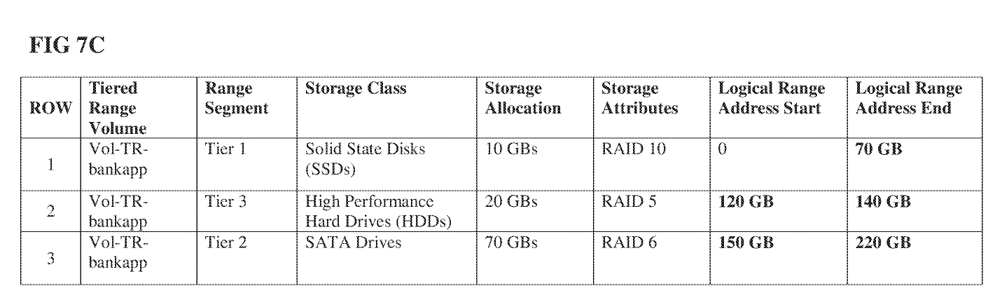

FIG. 3B depicts an embodiment of expanding the range of an existing storage portion within a tiered range volume. The storage manager 120 may be configured to expand the range of an existing storage portion if needed. Step 322 illustrates the step where the storage manager 120 expands the range of a specific storage portion. For example, if storage portion 410, which currently has a logical range of 0-10 GB, reaches capacity, then the storage manager 120 may expand the range of storage portion 410 to 0-20 GB. In an embodiment, the storage manager 120 may be configured with capacity thresholds for each storage portion where if the capacity of a specific storage portion reaches a defined capacity, the storage manager 120 requests for an expansion of the range of the specific storage portion. Since the logical address ranges mapped to the tiered range volume incorporate gaps between tiers, each storage portion may be expanded without disruption. In an embodiment, the storage manager 120 may request additional storage from the device manager 132. The device manager 132 may then provision more storage devices to the storage portion 410 in order to expand the range of storage portion from 0-10 GB to 0-20 GB. In another embodiment, the storage manager 120 may directly provision more storage devices from storage class tier 130 in order to extend the range of storage portion 410. FIG. 7A depicts an embodiment of an updated storage portion table where row 1 shows the updated logical range address end as 20 GB. In an embodiment, the migration policy may not need to be updated for expanding existing storage regions of a specific storage class tier.

Expanding the range of an existing storage portion within a tiered range volume is not limited by the logical regions of other storage portion defined by the storage portion table. For example, the range of storage portion 410 (tier 1), as depicted in FIG. 7A, is not limited to only having a maximum range of 0-20 GB. Storage portion 410 may be dynamically expanded beyond 20 GB. In an embodiment, storage portion 410 may be expanded by adding a second logical range to the storage portion table. FIG. 7B depicts adding a second logical range for storage portion 410 by adding row 4 to the storage portion table. Row 4 defines an additional part of storage portion 410 (tier 1) where the newly added storage allocation defines that storage portion 410 now comprises 70 GB total. The storage manager 120 then manages mapping to storage portion 410 as logical addresses between ranges 0-20 GB and 120-170 GB.

Another embodiment of expanding an existing storage portion involves remapping logical addresses of other storage portions in order to accommodate the expansion of the existing storage portion. For example, if storage portion 410 (tier 1 in FIG. 7A) is to be expanded from having a logical range from 0-20 GB to having a logical range of 0-70 GB then storage portion 605 and storage portion 415 may be remapped in order to maintain a single logical address range (0-70 GB) for storage portion 415. FIG. 7C depicts new logical range definitions for storage portions 410, 605, and 415. Storage portion 410 (tier 1) has been expanded to start at logical address 0 and end at logical address 70 GB. Storage portion 605 (tier 3) has been remapped to start at logical address 120 GB and end at logical address 140 GB. Storage portion 415 (tier 2) has been remapped to start at logical address 150 GB and end at logical address 220 GB. Remapping of tier 2 and tier 3 includes updating the logical-to-physical addresses of data to point to the new logical addresses based on the updated storage portion table (FIG. 7C).

FIG. 3B depicts an embodiment of reducing the range of an existing storage portion within a tiered range volume. In an embodiment, step 323 illustrates the storage manager 120 reducing the range of an existing storage portion. For example, if storage portion 605, which currently has logical range of 20 GB-50 GB, is not being fully utilized, then the storage manager 120 may reduce the range of storage portion 605 to 20 GB-40 GB. FIG. 7A depicts an embodiment of an updated storage portion table where row 2 shows the updated logical range address end as 40 GB.

In an embodiment, the storage manager 120 may need to update the storage map if data resides in logical address space that was eliminated based upon the reduction of a specific storage portion range. If data corresponding to a range of data blocks were mapped to locations referring to logical address spaces between 40 GB and 50 GB, then the storage manager 120 would need to remap the data to a different tier location and move the data to that new location. Step 325 depicts the storage manager 120 remapping and migrating data to their new location. In an embodiment, the migrating of data to a new location may involve remapping and moving data to a different tier. In another embodiment, the migration of data to a new location may involve moving the data stored in a range of data blocks to a new range of data blocks within the same tier.

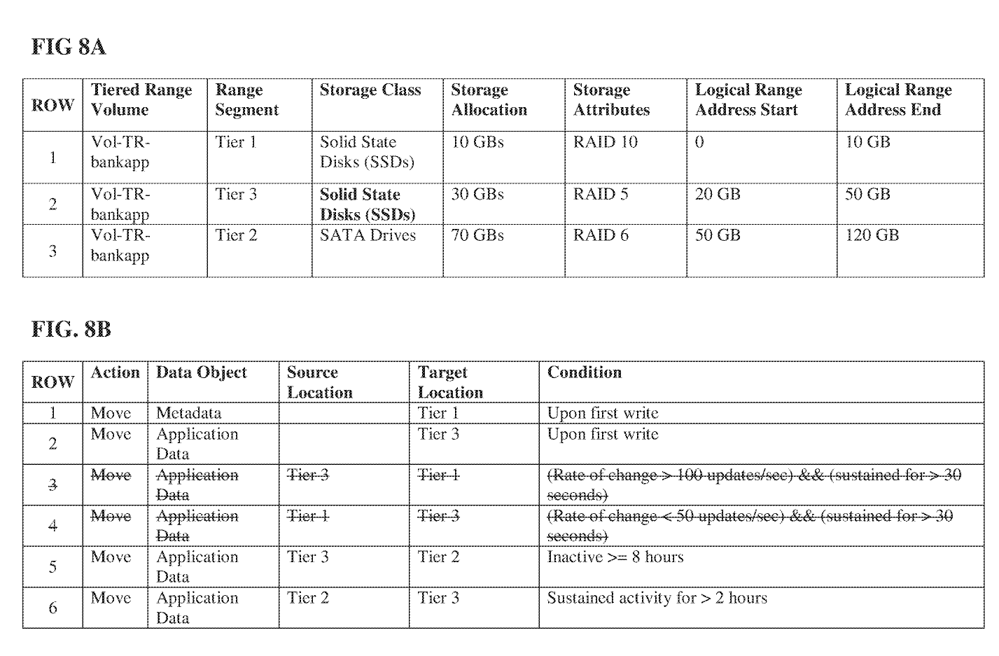

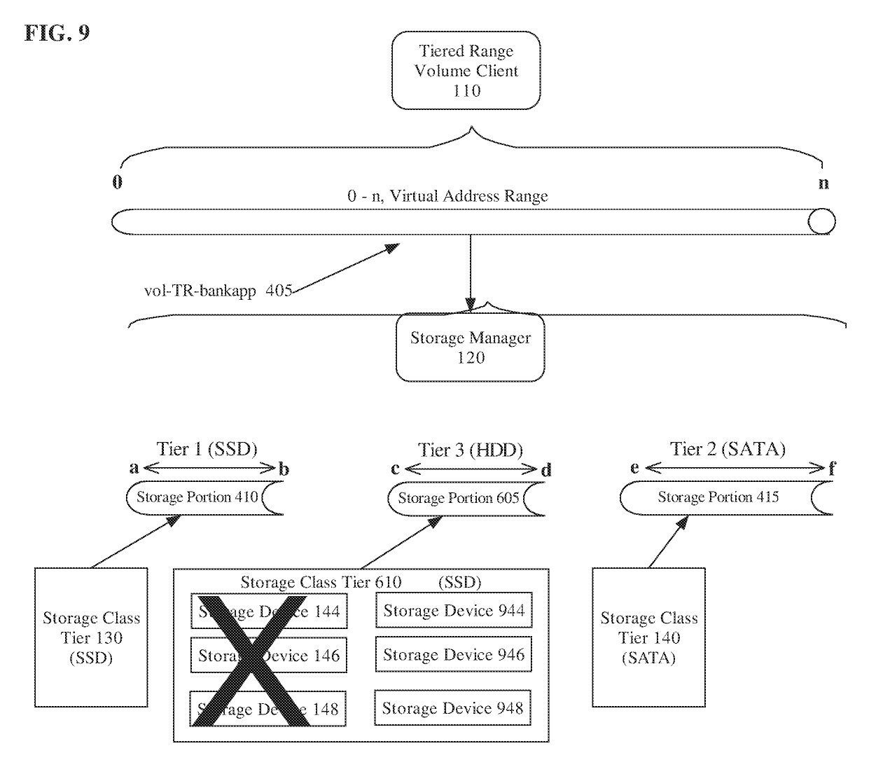

FIG. 3B depicts an embodiment of updating storage devices within an existing storage class tier transparent to the tiered range volume client. In an embodiment, step 324 illustrates the storage manager 120 updating the storage portion table and the migration policy to reflect changes related to the new properties of an updated storage class tier. For example, if the storage administrator decides to update devices in storage class tier 610 (high performance HDDs) to have high capacity SSDs, then at step 324 the storage manager would update the storage class characteristics in the storage portion table and update the migration policy to reflect the new capabilities of storage class tier 610. FIG. 9 illustrates updating storage devices within storage class tier 610. Storage devices 944, 946, and 948 represent the new high capacity SSDs and are meant to replace storage devices 144, 146, and 148 which are high performance HDDs. FIG. 8A depicts an embodiment of an updated storage portion table. The storage class column of row 2 has been updated to reflect the new characteristics of storage class tier 610. FIG. 8B depicts an embodiment of the current migration policy. Since tier 3 has been updated to faster performing SSDs, it may not be necessary for the storage manager 120 to migrate heavily accessed application data to tier 1 (SSDs). Therefore the storage manager 120 may implement an updated migration policy where rows 3 and 4 have been removed. FIG. 8B depicts the removal with a strikeout of rows 3 and 4.

In an embodiment, step 325 illustrates the storage manager 120 implementing the updated migration policy and modifying tiered range volume mappings for data that need to be migrated. In the case of replacing existing storage device with new ones, the storage manager 120 migrates all data on storage devices 144, 146, and 148 to the new storage devices 944, 946, and 948. In addition the storage manager 120 is configured to migrate application data currently stored in tier 1 to tier 3 (storage devices 944, 946, and 948). The purpose for migrating all application data from tier 1 to tier 3 is because the updated migration policy has removed rules related to a tier 1 to tier 3 migration. FIG. 9 depicts the removal of storage devices 144, 146, and 148 with an “X” signifying that the storage devices have be removed from storage class tier 610.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

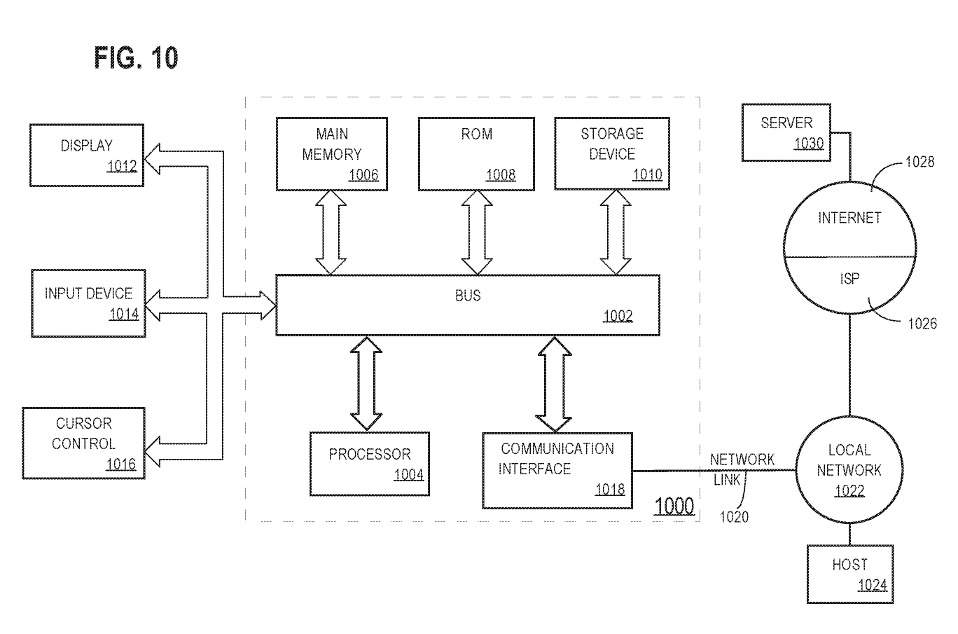

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
a storage manager creating a first tiered range volume, said storage manager exposing to a first tiered range volume client a first virtual address range for said first tiered range volume that represents logical addresses of data blocks within storage portions from at least two storage class tiers of a set of multiple storage class tiers;
wherein each storage portion of said storage portions is an allocated range from a respective storage class tier of said at least two storage class tiers;
wherein each storage class tier of said set of multiple storage class tiers comprises one or more types of storage devices;
said storage manager maintaining a storage map of said storage portions from said at least two storage class tiers to said first virtual address range;
wherein said storage map maps a first virtual address to a first logical address within a first storage portion from a first storage class tier of said at least two storage class tiers and a second virtual address to a second logical address within a second storage portion from a second storage class tier of said at least two storage class tiers;
storing a first data block at said first virtual address within said first storage portion;
said storage manager adding a third storage portion from a third storage class tier of said set of multiple storage class tiers to said first tiered range volume;
wherein adding said third storage portion comprises:
said storage manager modifying said storage map to map said first virtual address to a third logical address of said third storage portion;
moving said first data block to said third storage portion to a location corresponding to said first virtual address within said third storage portion of said third storage class tier.

2. The method of claim 1, further comprising:
said storage manager creating a second tiered range volume, said storage manager exposing to a second tiered range volume client a second virtual address range for said second tiered range volume that represents logical addresses of data blocks within storage portions from at least two storage class tiers of said set of multiple storage class tiers;
wherein said storage portions associated with said second tiered range volume are distinct from said storage portions associated with said first tiered range volume.

3. The method of claim 1, further comprising:
said storage manager removing said third storage portion from said first tiered range volume;
wherein removing said third storage portion comprises:
said storage manager modifying said storage map to map said first virtual address to another storage portion from said first tiered range volume;
moving said first data block to said another storage portion to a location corresponding to said first virtual address within said another storage portion from said first tiered range volume.

4. The method of claim 1, further comprising said storage manager expanding said allocated range of said third storage portion from said third storage class tier of said set of multiple storage class tiers.

5. The method of claim 4, wherein expanding said allocated range of said third storage portion is triggered automatically by a capacity threshold of said third storage portion.

6. The method of claim 1, wherein adding said third storage portion includes adding said third storage portion in response to determining that an access frequency threshold has been met for a type of data stored at said first virtual address.

7. The method of claim 1, further comprising:
said storage manager reducing said allocated range of said third storage portion from said third storage class tier of said set of multiple storage class tiers;
wherein a portion of said allocated range corresponds to said first virtual address;
wherein reducing said allocated range of said third storage portion comprises:
said storage manager modifying said storage map to map said first virtual address to another storage portion corresponding to said first tiered range volume;
moving said first data block to said another storage portion to a location corresponding to said first virtual address.

8. The method of claim 1, wherein storing said first data block at said first virtual address further comprises determining which storage portion to store said first data block based upon a data type of said first data block.

9. The method of claim 1, further comprising:
said storage manager migrating said first data block from said third storage portion to another storage portion based upon a configured rule for data characterized in said first data block;
wherein migrating said first data block comprises:
said storage manager modifying said storage map to map said first virtual address corresponding to said first data block to another storage portion from said first tiered range volume;
moving said first data block to said another storage portion to a location corresponding to said first virtual address within said another storage portion from said first tiered range volume.

10. The method of claim 9, wherein migrating said first data block is based upon access characteristics of said first data block by said first tiered range volume client.

11. One or more non-transitory computer-readable media storing instructions which, when executed by one or more computing devices, cause:
a storage manager creating a first tiered range volume, said storage manager exposing to a first tiered range volume client a first virtual address range for said first tiered range volume that represents logical addresses of data blocks within storage portions from at least two storage class tiers of a set of multiple storage class tiers;
wherein each storage portion of said storage portions is an allocated range from a respective storage class tier of said at least two storage class tiers;
wherein each storage class tier of said set of multiple storage class tiers comprises one or more types of storage devices;
said storage manager maintaining a storage map of said storage portions from said at least two storage class tiers to said first virtual address range;
wherein said storage map maps a first virtual address to a first logical address within a first storage portion from a first storage class tier of said at least two storage class tiers and a second virtual address to a second logical address within a second storage portion from a second storage class tier of said at least two storage class tiers;
storing a first data block at said first virtual address within said first storage portion;
said storage manager adding a third storage portion from a third storage class tier of said set of multiple storage class tiers to said first tiered range volume;
wherein adding said third storage portion comprises:
said storage manager modifying said storage map to map said first virtual address to a third logical address of said third storage portion;
moving said first data block to said third storage portion to a location corresponding to said first virtual address within said third storage portion of said third storage class tier.

12. The one or more non-transitory computer-readable media of claim 11, wherein the instructions, when executed by one or more processors, further cause:
said storage manager creating a second tiered range volume, said storage manager exposing to a second tiered range volume client a second virtual address range for said second tiered range volume that represents logical addresses of data blocks within storage portions from at least two storage class tiers of said set of multiple storage class tiers;
wherein said storage portions associated with said second tiered range volume are distinct from said storage portions associated with said first tiered range volume.

13. The one or more non-transitory computer-readable media of claim 11, wherein the instructions, when executed by one or more processors, further cause:
said storage manager removing said third storage portion from said first tiered range volume;
wherein removing said third storage portion comprises:
said storage manager modifying said storage map to map said first virtual address to another storage portion from said first tiered range volume;
moving said first data block to said another storage portion to a location corresponding to said first virtual address within said another storage portion from said first tiered range volume.

14. The one or more non-transitory computer-readable media of claim 11, wherein the instructions, when executed by one or more processors, further cause, said storage manager expanding said allocated range of said third storage portion from said third storage class tier of said set of multiple storage class tiers.

15. The one or more non-transitory computer-readable media of claim 14, wherein expanding said allocated range of said third storage portion is triggered automatically by a capacity threshold of said third storage portion.

16. The one or more non-transitory computer-readable media of claim 11, wherein adding said third storage portion includes adding said third storage portion in response to determining that an access frequency threshold has been met for a type of data stored at said first virtual address.

17. The one or more non-transitory computer-readable media of claim 11, wherein the instructions, when executed by one or more processors, further cause:
said storage manager reducing said allocated range of said third storage portion from said third storage class tier of said set of multiple storage class tiers;
wherein a portion of said allocated range corresponds to said first virtual address;
wherein reducing said allocated range of said third storage portion comprises:
said storage manager modifying said storage map to map said first virtual address to another storage portion corresponding to said first tiered range volume;
moving said first data block to said another storage portion to a location corresponding to said first virtual address.

18. The one or more non-transitory computer-readable media of claim 11, wherein storing said first data block at said first virtual address further comprises determining which storage portion to store said first data block based upon a data type of said first data block.

19. The one or more non-transitory computer-readable media of claim 11, wherein the instructions, when executed by one or more processors, further cause:
said storage manager migrating said first data block from said third storage portion to another storage portion based upon a configured rule for data characterized in said first data block;
wherein migrating said first data block comprises:
said storage manager modifying said storage map to map said first virtual address corresponding to said first data block to another storage portion from said first tiered range volume;
moving said first data block to said another storage portion to a location corresponding to said first virtual address within said another storage portion from said first tiered range volume.

20. The one or more non-transitory computer-readable media of claim 19, wherein migrating said first data block is based upon access characteristics of said first data block by said first tiered range volume client.
